(19) United States
(12) Patent Application Publication
(10) Pub. No.: US 2015/0205786 A1
(43) Pub. Date: Jul. 23, 2015

(54) PROBLEM SITUATION DETECTION DEVICE, PROBLEM SITUATION DETECTION METHOD AND PROBLEM SITUATION DETECTION-USE PROGRAM

(71) Applicant: NEC Corporation, Minato-ku, Tokyo (JP)

(72) Inventors: Yuzuru Okajima, Tokyo (JP); Satoshi Nakazawa, Tokyo (JP); Itaru Hosomi, Tokyo (JP)

(21) Appl. No.: 14/417,871

(22) PCT Filed: Jul. 11, 2013
(86) PCT No.: PCT/JP2013/068997

§ 371 Date: Jan. 28, 2015

(30) Foreign Application Priority Data
Jul. 31, 2012 (JP) 2012-169606

(51) Int. Cl. G06F 17/27

(52) U.S. Cl. CPC G06F 17/2745

(57) ABSTRACT

The present invention does not simply extract all situations likely to become problems without any criteria; from among situations mentioned within text, the invention detects situations that a writer particularly considers to be a problem. From text for which detection is to be performed, descriptions representing events mentioned in the text are extracted in units of situations for each of the events. From among the extracted situations, a situation that the writer who has described the situation assumes to be a situation that actually occurs, and/or a situation that is not an ancillary explanatory description, is sorted out as a situation in which the writer has interest. From among the sorted out situations, a situation that includes at least one expression that may become a problem is output as a problem situation.

### TECHNICAL FIELD

The present invention relates to a problem situation detection device, a problem situation detection method, and a program for problem situation detection that detects a problematic situation from an input text.

### BACKGROUND ART

With prevalence of personal computers and the like, processing languages as texts has become common. Accordingly, a natural language processing technology in which a computer processes natural languages that are languages people use in everyday lives is being developed. Moreover, with development of a network technology such as the Internet, texts created not only by specific users but also by various users are spreading widely.

In such circumstances, detecting a problematic expression from a text is beneficial. In order to detect a problematic expression from a text like this, for example, wording that is associated to a crime is determined in advance as a keyword. Then, the keyword is detected from texts in a bulletin board site that is constructed on the Internet. Accordingly, an inappropriate rumor and a criminal threat can be monitored.

However, when a description is extracted based only on whether or not keywords are matched with, a description other than a description that is sought for may possibly be extracted. This problem will be described with a specific example. For example, assume that wording of “arson” is determined as a keyword in order to find a criminal threat. In such a case, a criminal threat using the wording “arson” may possibly be extracted and found. However, at the same time, many descriptions irrelevant to the criminal threat itself, such as press articles and trial records related to past incidents of arson and legal descriptions of arson, are extracted.

For this reason, there is a technology that not only extracts a portion that includes a problematic expression from a text but also checks how the expression is treated in the text.

For example, in a quotation determining method and a reputation extracting method using the same, that is a technology described in PTL 1, in order to address a problem of detecting a text of a news article cited in a text as a result of attempting to extract reputation from a blog and the like, a portion in which a news article is cited in the text is determined, whereby reputation information is extracted from the text exclusive of the cited portion. By using the technology described in PTL 1, a problematic expression can be extracted only from sentences written by a user oneself.

In an information collection device which is a technology described in PTL 2, to achieve an object of extracting only experiences of a writer from a blog and the like, expressions that represent hearsay and honorific expressions are focused to extract only experiences of the writer oneself. By using the technology described in PTL 2, a problematic expression can be extracted from a portion in which an experience of a user oneself is described.

### CITATION LIST

### Patent Literature

PTL 1: Japanese Unexamined Patent Application Publication No. 2010-067243
PTL 2: Japanese Unexamined Patent Application Publication No. 2007-299076

### SUMMARY OF INVENTION

### Technical Problem

By using the techniques described in the respective patent literatures above and the like, an expression that is likely to be problematic in a text can be extracted more efficiently.

By the way, there is a case that a problem expression should be detected only when a writer considers that the problem expression is in fact a problem, rather than extracting all expressions that are likely to be problematic in the text.

For example, assume that there is a system for mental health care that extracts a problematic event from a text created by a certain person and outputs advice based on the extracted result.

In such a case, the problem expression is an expression representing an event that is problematic in terms of mental health of a user of the system. Assume that this system is configured to retain a dictionary of expressions that represent problematic events and, when an expression that represents a problematic event is found, issue advice with regard to the expression.

Specifically, for example, this system retains a problem expression of “angry,” and, when a text “Wife is angry” is input, the system detects the problematic expression “angry” and outputs advice such as “It must be hard on you that ‘Wife is angry.’ Please deal with the matter with composure.”

Such a system needs to issue advice for an event that a writer considers as problematic.

However, a method of simply extracting all problematic expressions embodies a problem of extracting expressions other than an event that the writer considers as problematic.

For example, in response to a text “As I asked the reason because Wife was angry, apparently, it seems that the child is bullied at school,” an advice such as “It must be hard on you that ‘Wife was angry.’ Please deal with the matter with composure.” is output. Such an advice does not match a situation that the writer considers as problematic, and is inappropriate. This is because a problem in this text is not the fact that “Wife was angry,” but the point that “the child is bullied at school” which is considered as the reason for the wife's anger. Thus, in such a case, an advice for the point that “the child is bullied at school” that the writer of the text considers as problematic should be output.

If a person is a subject who reads the text and comprehends contents thereof, the person may deduce that “the child is bullied at school” is a more significant problem than “Wife was angry” for the writer of the text. Indeed, when a computer is the subject who reads the text and comprehends the contents, it is difficult with known technologies to mechanically make such a determination.

For example, such a problem cannot be solved with the technologies described in the respective patent literatures that have been described above as an example of known technologies.

This is because, while the technology described in PTL 1 can eliminate a cited portion, the portion of “Wife was angry” in the above example is a sentence written by the user oneself, thus, the portion cannot be eliminated.

Moreover, this is because, while the technology of PTL 2 can extract only the writer's own experience, a problem situation such as the above example, “it seems that the child is bullied at school” that is not an experience of the writer oneself, yet the writer considers as problematic, cannot be detected.

Thus, an object of the present invention is to provide a problem situation detection device, a problem situation detection method, and a program for problem situation detection which can detect a situation that a writer considers as particularly problematic among situations mentioned in a text, rather than simply and randomly extracting all situations which are likely to be problematic.

### Solution to Problem

According to a first aspect of the present invention, the provided is a problem situation detection device includes: a situation extraction unit which extracts, from a text as a detection target, descriptions that represent events mentioned in the text in units of situations separately for the events; an interest situation screening unit which performs sorting out, among the situations which are extracted, both or one of a situation that a writer who writes the situation assumes to be realized and a situation that is not an ancillary description as a situation that the writer is concerned with; and a problematic degree assessment unit which outputs, as a problem situation, a situation that includes at least one expression which is likely to be a problem among the situations which are sorted out.

According to a second aspect of the present invention, the provided is a problem situation detection method includes: extracting, from a text as a detection target, descriptions that represent events mentioned in the text in units of situations separately for the events; performing sorting out, among the situations which are extracted, both or one of a situation that a writer who writes the situation assumes to be realized and a situation that is not an ancillary description as a situation that the writer is concerned with; and outputting, as a problem situation, a situation that includes at least one expression which is likely to be a problem among the situations which are sorted out.

According to a third aspect of the present invention, the provided is a program for problem situation detection causes a computer to function as a problem situation detection device, including: a situation extraction unit which extracts, from a text as a detection target, descriptions that represent events mentioned in the text in units of situations separately for the events; an interest situation screening unit which performs sorting out, among the situations which are extracted, both or one of a situation that a writer who writes the situation assumes to be realized or a situation that is not an ancillary description as a situation that the writer is concerned with; and a problematic degree assessment unit which outputs, as a problem situation, a situation that includes at least one expression which is likely to be a problem among the situations which are sorted out.

### Advantageous Effects of Invention

According to the problem situation detection device, the problem situation detection method, and the program for problem situation detection of the present invention, a situation that a writer considers particularly as problematic can be detected among situations mentioned in a text, rather than simply and randomly extracting all situations which are likely to be problematic.

### BRIEF DESCRIPTION OF DRAWINGS

FIG. 1 is a diagram illustrating a basic hardware structure of a problem situation detection device according to an exemplary embodiment of the present invention;

FIG. 2 is a block diagram illustrating a basic functional structure of the problem situation detection device according to the exemplary embodiment of the present invention;

FIG. 3 is a diagram illustrating an example of data to be input to a situation extraction unit of the exemplary embodiment of the present invention;

FIG. 4 is a flowchart illustrating a basic operation of the problem situation detection device of the exemplary embodiment of the present invention;

FIG. 5 is a diagram illustrating an example of data to be output by the situation extraction unit of the exemplary embodiment of the present invention;

FIG. 6 is a diagram illustrating an example of a situation extraction processing that the situation extraction unit of the exemplary embodiment of the present invention performs;

FIG. 7 is a diagram illustrating an example of data that an achievement degree assessment unit of the exemplary embodiment of the present invention refers to for assessment;

FIG. 8 is a diagram illustrating an example of data to be output by the achievement degree assessment unit of the exemplary embodiment of the present invention;

FIG. 9 is a diagram illustrating an example of data to be referred to by an ancillary description degree assessment unit of the exemplary embodiment of the present invention for assessment;

FIG. 10 is a diagram illustrating an example of data to be output by the ancillary description degree assessment unit of the exemplary embodiment of the present invention;

FIG. 11 is a diagram illustrating an example of a combination of data to be output by the achievement degree assessment unit of the exemplary embodiment of the present invention and data to be output by the ancillary description degree assessment unit 30;

FIG. 12 is a diagram illustrating an example of data to be output by an interest situation screening unit of the exemplary embodiment of the present invention;

FIG. 13 is a diagram illustrating an example of data retained by a problem expression dictionary of the exemplary embodiment of the present invention; and

FIG. 14 is a diagram illustrating an example of data to be output by a problematic degree assessment unit of the exemplary embodiment of the present invention.

### DESCRIPTION OF EMBODIMENTS

Next, details of an exemplary embodiment of the present invention will be described with reference to the drawings.

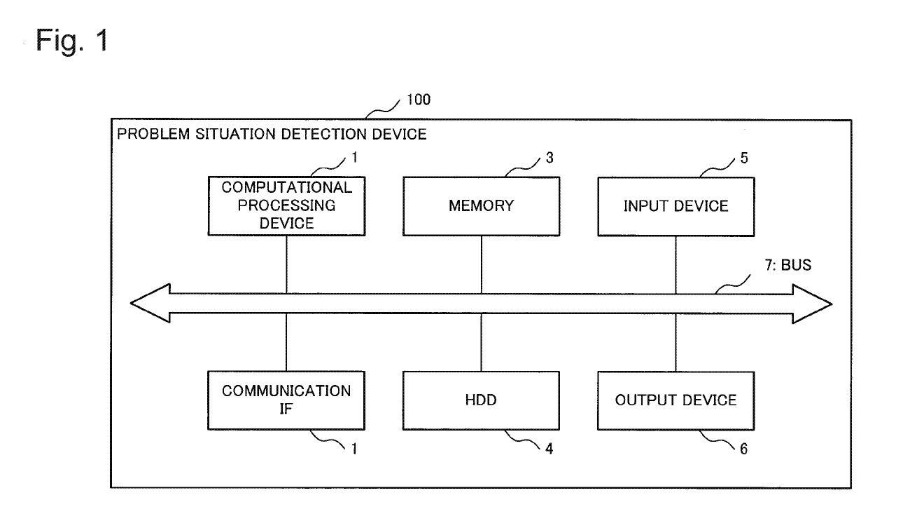

FIG. 1 is a diagram illustrating an example of a hardware structure of a problem situation detection device 100 according to the exemplary embodiment of the present invention.

Referring to FIG. 1, the problem situation detection device 100 includes an computational processing device 1, a communication interface (IF) 2, a memory 3, a hard disk drive (HDD) 4, an input device 5, and an output device 6.

Moreover, these components are connected to one another through a bus 7, thus data are mutually input and output.

The computational processing device 1 is an computational processing device for controlling the entire problem situation detection device 100 and, for example, realized by a CPU (Central Processing Unit).

The communication interface 2 is an interface that allows the problem situation detection device 100 to communicate with the outside. Communication may be realized either by directly connecting by wire with equipment at a communication destination through a cable and the like, or by connecting with equipment at a communication destination via a network, a part or whole of which consists of wireless connection. To the extent that the communication interface 2 conforms to an arbitrary standard or communication method, there is no limitation to the interface standard and communication method.

Further, the memory 3 is a primary storage device that the computational processing device 1 accesses when performing computational processing. The memory 3 is realized by, for example, an SDRAM (Synchronous Dynamic Random Access Memory).

Further, the hard disk drive 4 is a storage device that functions as an auxiliary storage device.

The hard disk drive 4 stores a program that is dedicated to the present exemplary embodiment for causing a computer to function as the problem situation detection device 100. Herein, the problem situation detection device 100 may be realized either by a device that is dedicated to the present exemplary embodiment or by incorporating software that is dedicated to the present exemplary embodiment into a general-purpose personal computer, a server device, or the like. In any case, the problem situation detection device 100 is realized when the computational processing device 1 performs computational processing by reading a program that is dedicated to the present exemplary embodiment from the hard disk drive 4 and controls a variety of hardware in accordance with a result of this computational processing. Note that the problem situation detection device 100 may be realized either by a single device or by a plurality of devices that jointly operate.

Further, the input device 5 is a device with which a user operates the problem situation detection device 100 and is realized by, for example, a keyboard and a mouse. The output device 6 is a device for presenting information to a user and is realized by, for example, a display or the like. Note that the output device 6 may be realized by, for example, a printer that prints a processing result.

Note that the structure illustrated in FIG. 1 is merely an example, and therefore, the invention may further include other components not illustrated. Moreover, the illustrated components may be replaced with other devices.

For example, sound collection equipment, such as a microphone, may further be included so as to accept a voice input. Further, for example, the input device 5 and output device 6 may be integrally formed and be realized as a touch panel, and the hard disk drive 4 may be replaced with a Flash SSD (Solid State Drive) that uses a flash memory as a semiconductor memory. Moreover, an interface for attaching a detachable storage medium for storing the processing result may further be included.

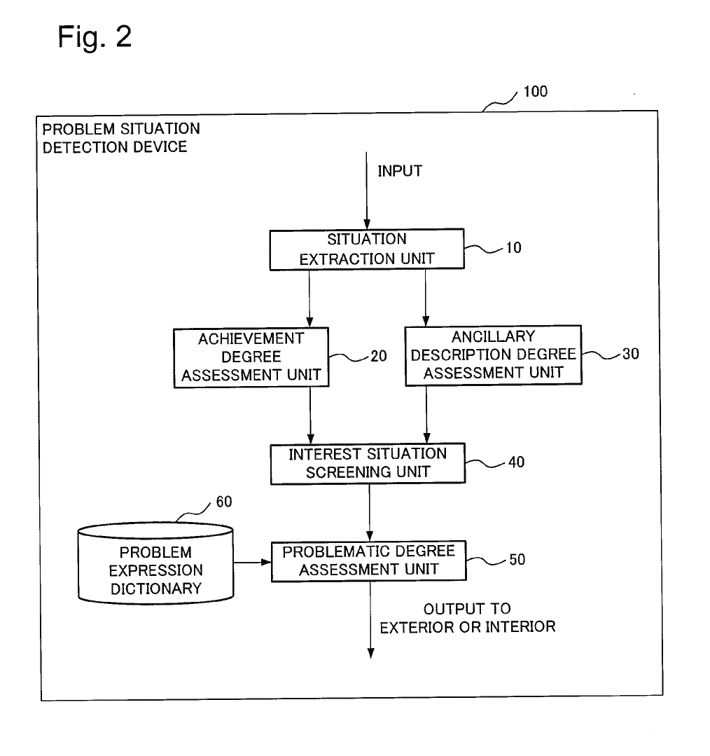

FIG. 2 is a diagram illustrating functional blocks included in the problem situation detection device 100 of the present exemplary embodiment. Referring to FIG. 2, the problem situation detection device 100 includes a situation extraction unit 10, an achievement degree assessment unit 20, an ancillary description degree assessment unit 30, an interest situation screening unit 40, a problematic degree assessment unit 50, and a problem expression dictionary 60.

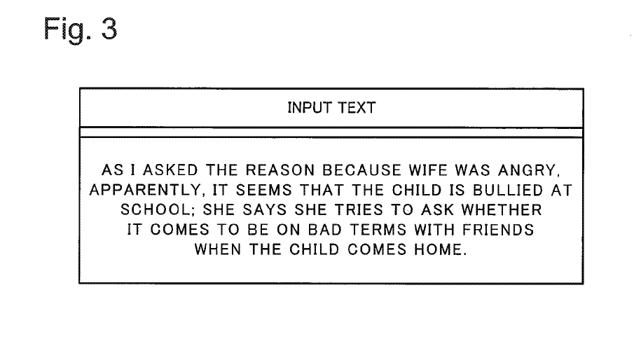

Herein, functions of the respective blocks will be described. For easier understanding of the functions of the respective blocks, a specific example will be used in the description. FIG. 3 illustrates a specific example of a text to be input to the problem situation detection device 100.

In the following, description will be given on the operation based on this specific example of the text.

First, before going to description of each block, a basic idea of realizing the present exemplary embodiment will be described to facilitate understanding of the present exemplary embodiment.

In the following description of the present exemplary embodiment and the present invention, a variety of events that are mentioned in a text to be processed are referred to as “situations.” For example, in the specific example of the text illustrated in FIG. 3, a plurality of events, such as “Wife was angry” and “the child is bullied at school,” are included. These events, “Wife was angry,” “the child is bullied at school,” and the like, are the “situations” included in the text.

Further, the “situations” are not limited to events that happened or happen at a specific time and at a specific place, yet, include descriptions of characteristics of general things.

For example, even when a description is about characteristics of general things, such as “water flows to lower places,” the description may be considered to be a situation and therefore, the present exemplary embodiment may be adapted to the description. Further, the situation does not always have to be an objective description that indicates the truth. Even with a description that is based on a subjective opinion of a writer such as “all human beings are foolish,” the description may be considered as a situation and therefore, the present exemplary embodiment may be adapted to the description.

Herein, the object of the present exemplary embodiment is to provide a technology detecting a situation that a writer considers as problematic among situations mentioned in a text, rather than simply extracting all situations which are likely to be problematic.

Note that in the present exemplary embodiment and present invention, “a situation that a writer considers as problematic” means a situation that other people, when reading the text, deduce that the writer must consider the situation as problematic.

Taking the above-described example, detecting “a situation that a writer considers as problematic” is to detect “the child is bullied at school” as a more significant problem for the writer than “Wife was angry.”

As such, the object is to mechanically detect what people can deduce. Note that the object of the description of the present exemplary embodiment and the present invention is to detect among situations described in a text, and is not intended to detect the writer's idea that is not written in the text.

In the present exemplary embodiment, in order to detect a situation that a writer considers as problematic, two kinds of degrees, “achievement degree” and “ancillary description degree,” are used as scales.

Herein, the achievement degree is a value quantifying a degree of likelihood of a writer considering that the situation already becomes a reality or will become a reality for each situation described in a text.

Further, the ancillary description herein refers to information added in a text in order to facilitate understanding of a primary description that a writer wants to claim. The ancillary description is, for example, an additional description of a place and a time that an event took place. In addition, the ancillary description degree is a value that quantifies a degree of likelihood that a situation is used as ancillary description in the text for each of the situations included in the text.

Then, in the present exemplary embodiment, among all situations included in the text, a situation that satisfies two conditions: the situation has an achievement degree that the writer considers to be high and the situation that the writer is not using for an ancillary description, is sorted out as a situation for which the writer has a high degree of concern. Accordingly, the present exemplary embodiment sorts out a situation that includes a problematic expression among the situations, then, outputs the situation that is sorted out.

Such a determination is based on two major reasons. The first reason is that a situation that the writer considers as having a low achievement degree is unlikely to be a situation that the writer oneself considers as problematic.

Further, the second reason is that, when a situation is used for an ancillary description, even when the situation is considered as having a high achievement degree, the situation is not a point the writer wants to claim, and such a situation is unlikely to be a situation that the writer oneself considers as problematic.

Then, by determining in consideration of the achievement degree and the ancillary description degree, a situation that has a high achievement degree yet is used for an ancillary description and a situation that is included in the primary description yet has a low achievement degree can be eliminated. Further, such situations can be eliminated before sorting out a situation that includes a problematic expression, and as a result, only a situation that the writer considers as problematic can be output.

The above is the basic idea for realizing the present exemplary embodiment. The description will continue with reference to FIG. 2.

First, the problem situation detection device 100 accepts a text as an input. This text may be any text to the extent that the text represents a natural language sentence written by a person.

When a text is input to the problem situation detection device 100, the situation extraction unit 10 extracts “situations” that are included in the input text and are a variety of events mentioned in the text, then, outputs the situations that is extracted. Note that the situation extraction unit 10 as well as the achievement degree assessment unit 20, the ancillary description degree assessment unit 30, the interest situation screening unit 40, and the problematic degree assessment unit 50, as will be described later, are realized by, for example, computational processing performed by the computational processing device 1 illustrated in FIG. 1. Further, the problem expression dictionary 60 is, for example, stored in the hard disk drive 4 illustrated in FIG. 1.

Next, the achievement degree assessment unit 20 outputs an “achievement degree” with regard to each of the situations output by the situation extraction unit 10. Herein, the achievement degree is a value that quantifies a degree of likelihood of a writer thinking that the situation already becomes a reality or will become a reality for each situation output by the situation extraction unit 10.

The ancillary description degree assessment unit 30 determines, each of the situations output by the situation extraction unit 10, a degree of likelihood that the situations is used as an ancillary description in the text.

For the respective situations output by the situation extraction unit 10, the interest situation screening unit 40 sorts out a situation that the writer is concerned with among the situations described in the text, based on two kinds of degrees: the achievement degree output from the achievement degree assessment unit 20, and the ancillary description degree output from the ancillary description degree assessment unit 30.

The problematic degree assessment unit 50 examines, for the respective situations output by the interest situation screening unit 40, whether the situation includes a problem by using the problem expression dictionary 60, and extracts only the situation that includes a problem. Then, the problematic degree assessment unit 50 outputs the extracted situation to the inside or the outside of the problem situation detection device 100 as a problem situation.

The output destination is, for example, a display that realizes the output device 6. The output destination may be other than the display, such as any recording medium being external or internal of the problem situation detection device 100 and may be another functional block, which is not illustrated in FIG. 2, being external or internal of the problem situation detection device 100. The extracted situation may be output to other devices connected to an external network via the communication interface 2.

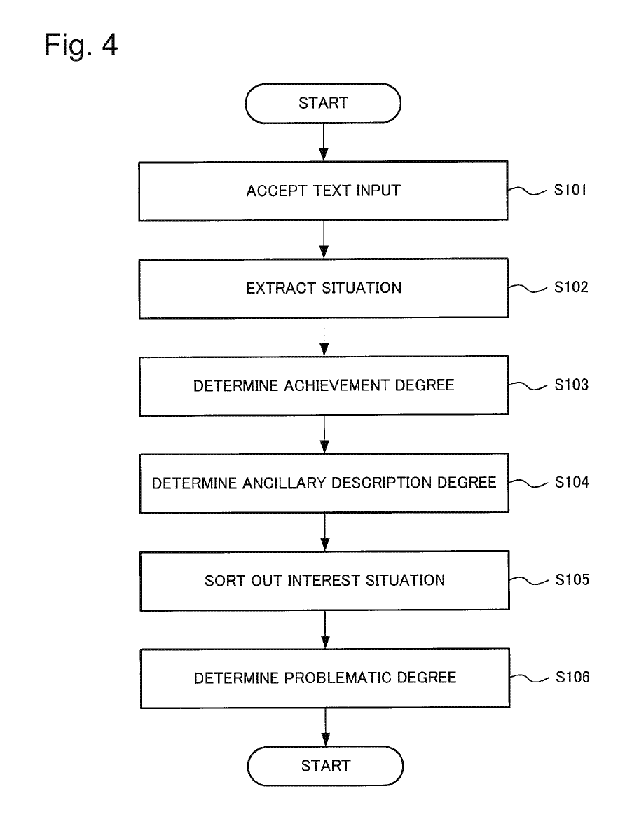

The following is a description on an example of the operation of the problem situation detection device 100 with reference to FIG. 4 that is a flowchart that indicates the operation of the problem situation detection device 100. In the following description, after a brief description of a flow of the whole processing of the problem situation detection device 100, processing of each step will be individually described in detail.

First, the situation extraction unit 10 accepts an input of a text from a user (step S101).

Next, the situation extraction unit 10 extracts a situation from the input text and outputs the extracted situation (step S102).

Next, the achievement degree assessment unit 20 outputs, as an achievement degree, a value that quantifies a degree of possibility of a writer considering that the situation already becomes a reality or will become a reality for each of the situations output by the situation extraction unit 10 (step S103).

Meanwhile, the ancillary description degree assessment unit 30 determines, for each of the situations output by the situation extraction unit 10, a degree of likelihood that the situation is claimed as an ancillary description in the text (step S104).

Note that, while the step S104 is performed after the step S103 in FIG. 4 and the above description, the order is decided only for convenience of illustrating the flowchart. The ancillary description degree assessment unit 30 may perform the step S103 after the step S104 by switching the order. Alternatively, by dividing processing of the step S103 and the step S104 respectively, the ancillary description degree assessment unit 30 may alternately perform the divided processing of the step S103 and the step S104. When the computational processing device 1 includes a plurality of computational processing units (cores), the computational processing device 1 may perform the processing of the step S103 and the step S104 in parallel.

Next, for the respective situations output by the situation extraction unit 10, the interest situation screening unit 40 sorts out situations that the writer is concerned with among the situations described in the text, based on an achievement degree output by the achievement degree assessment unit 20 and an ancillary description degree output by the ancillary description degree assessment unit 30 (step S105).

The problematic degree assessment unit 50 examines whether the situation includes a problem by using the problem expression dictionary 60 for the respective situations output by the interest situation screening unit 40 and outputs only the situation that includes a problem as a problem situation (step S106).

In the following, details of individual processing in each step will be specifically described.

First, an operation of the step S101 will be described. In the present exemplary embodiment, the situation extraction unit 10 may accept an input of a text from a user in any manner. For example, when the input device 5 is realized as a keyboard, the problem situation detection device 100 may accept an input of a text through this keyboard.

Further, the input device 5 may be realized by a microphone so that the problem situation detection device 100 may accept a voice input from a user. In such a case, the computational processing device 1 may further convert the accepted voice input into a text by a voice recognition technology.

Furthermore, the problem situation detection device 100 may accept an input of a text, for example, from other devices connected to an external network via the communication interface 2. Further, a user may input a text by specifying a data file that stores the text. In such a case, the situation extraction unit 10 reads the text from the data file specified by the user. The data file may be stored in the hard disk drive 4. The problem situation detection device 100 may accept an input of a text by reading a data file in an external storage medium such as a memory that conforms the USB (Universal Serial Bus) standard or a BD (Blue-ray Disc; registered trademark).

Further, a scanner may be connected as the input device 5. This scanner may scan a paper medium on which a text is written, and the situation extraction unit 10 may convert the scanned content into a text by a technology generally called OCR (Optical Character Recognition).

Next, an operation of the step S102 will be specifically described. In the present exemplary embodiment, the situation extraction unit 10 extracts a situation from the input text and outputs the extracted situation. Extraction of a situation from a text by the situation extraction unit 10 is realized by structuring the text by a known common technology, such as morphological analysis and syntax analysis, and extracting a part of the structured text.

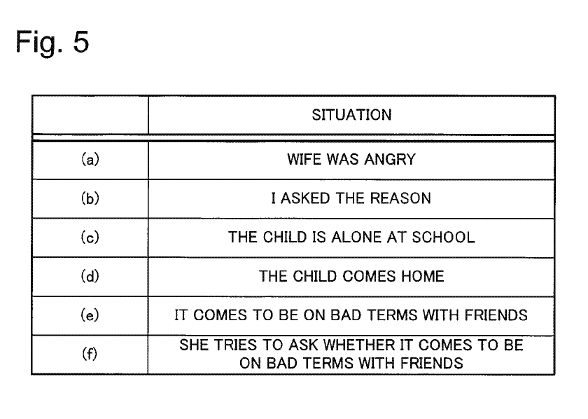

FIG. 5 is a diagram illustrating an example of data output by the situation extraction unit 10. FIG. 5 illustrates an example of situations extracted from the example of the text illustrated in FIG. 3.

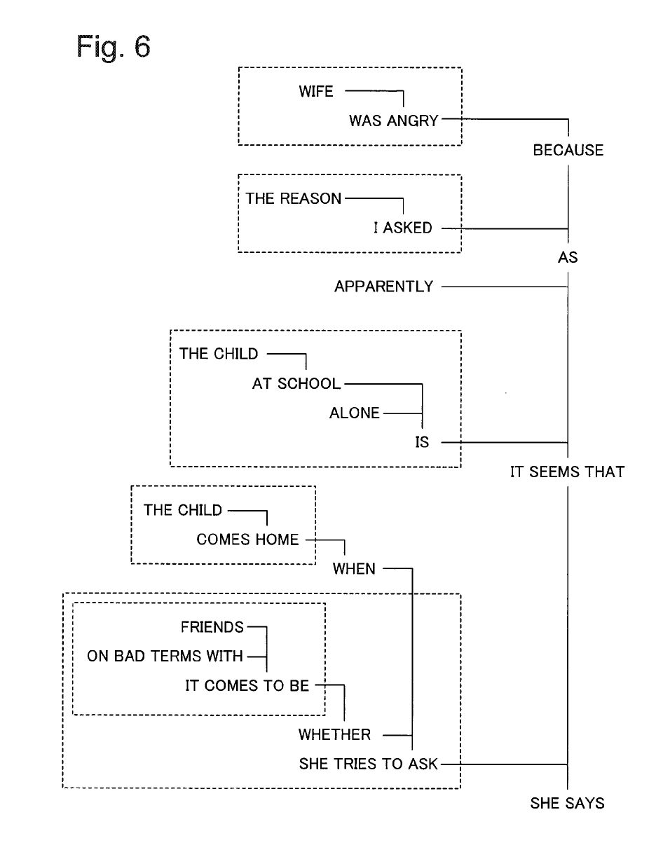

FIG. 6 illustrates an example of processing for extracting situations as illustrated in FIG. 5 from a text. FIG. 6 illustrates a tree structure of a text processed by a syntax analyzer, where the situations illustrated in FIG. 5 are extracted by extracting clauses that include predicates and clauses that modify the predicates. Each portion surrounded by a broken line indicates an individual situation included in the text. Wording included in a text may be a constituent of one situation or a constituent of a plurality of situations. For example, the wording “Wife” and “was angry” are constituents of only a situation (a) in FIG. 5. Meanwhile, the respective wording of “his friends,” “on bad terms with,” and “becomes” are not only constituents of a situation (e) but also constituents of a situation (f) in FIG. 5. On the other hand, there may be wording that is not a constituent of a situation, such as “apparently.”

Note that situations may be output in a text format, as illustrated in FIG. 5, with which specified events are comprehensible when being read by people. Alternatively, the situations may be output in a form of a sub tree of a tree structure as illustrated in FIG. 6.

Situations extracted by the situation extraction unit 10 may include an event that has not actually happened. For example, the situation (d) “the child comes home” illustrated in FIG. 5 describes a future event “when the child comes home” in the original text, which has not actually happened yet. However, such an event may also be extracted as a situation.

Next, an operation of the step S103 will be specifically described. The achievement degree assessment unit 20 outputs, as an achievement degree, a value that quantifies a degree of likelihood of a writer considering that the situation already becomes a reality or will become a reality for each situation output by the situation extraction unit 10. In the example of the present exemplary embodiment, the achievement degree assessment unit 20 outputs 1 for a situation that is determined as “the writer considers that the situation already becomes a reality or will become a reality.” On the other hand, the achievement degree assessment unit 20 outputs 0 for other situations.

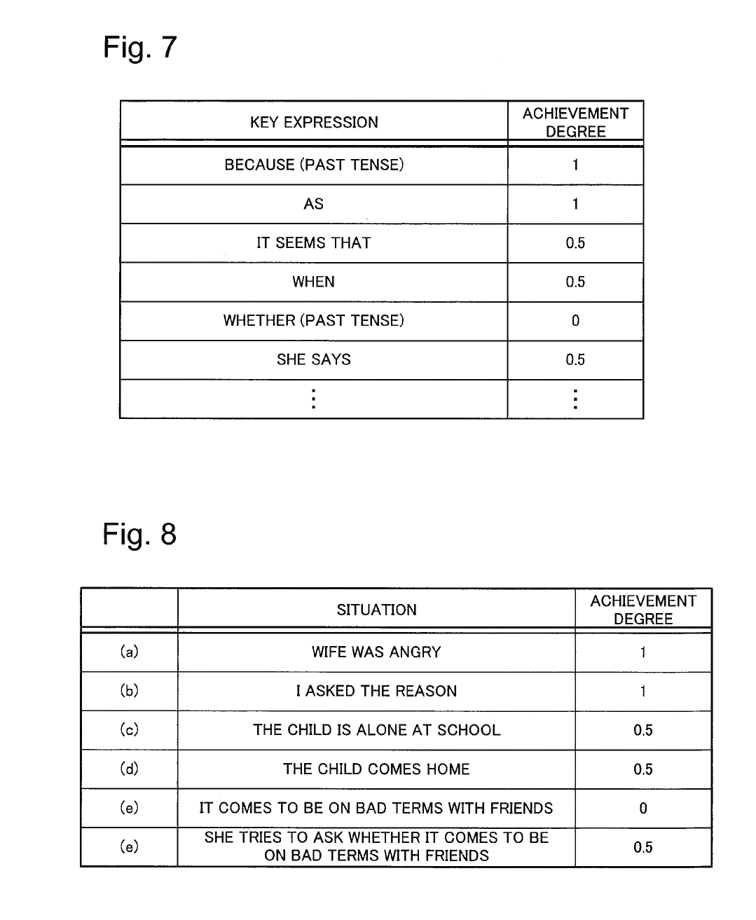

Although an arbitrary method may be used to determine the achievement degree, the present exemplary embodiment uses achievement degrees that are linked to key expressions as illustrated in FIG. 7 that appear around the situations. Herein, FIG. 7 is a diagram illustrating an example of a rule of key expressions that appear around the situations and achievement degrees. For example, the achievement degree assessment unit 20 stores a rule that an expression that indicates a cause such as “because (past tense)” represents an event that has actually happened.

Note that the rule illustrated in FIG. 7 is merely an example, and a rule can be arbitrarily set in accordance with an implementation environment. Further, there is no limit to the number of combinations of key expressions and achievement degrees included in a rule and therefore, an arbitrary number thereof may be set.

According to the rule in FIG. 7, as described above, when an expression of “because (past tense)” is included in an extracted situation, the description is considered to be about a situation that has already become a reality. Thus, the achievement degree assessment unit 20 outputs 1 as the achievement degree with regard to this situation.

On the other hand, when an expression of “whether (past tense)” is included in an extracted situation, this expression is considered neither as an expression that represents a situation that will become a reality nor that the writer recognizes as having already become a reality. Thus, the achievement degree assessment unit 20 outputs 0 as the achievement degree with regard to this situation.

Further, in the present exemplary embodiment, the achievement degree may be determined by a dualism of, for example, 1 or 0. However, when the situation includes an expression that represents hearsay or conjecture, such as “it is said,” the achievement degree assessment unit 20 may determine that the achievement degree is at a moderate level, thereby outputting an intermediate value such as 0.5.

FIG. 8 illustrates an example of achievement degrees output by the achievement degree assessment unit 20. This example is a result of output of the achievement degree assessment unit 20 when a rule as illustrated in FIG. 7 is applied to the example of the situations output by the situation extraction unit 10 illustrated in FIG. 5 or 6.

Herein, each situation will be individually examined. Since the situation (a) “Wife was angry” is written as “because Wife was angry” in the source text, the writer of the text describes this situation as an event that has actually happened. Thus, the achievement degree assessment unit 20 outputs 1 with regard to the situation (a) “Wife was angry.”

Meanwhile, the situation (d) “it comes to be on bad terms with friends” is a content to be asked afterwards when the child comes home, and the writer does not mention whether this incident is an event that has actually happened. Thus, the achievement degree assessment unit 20 outputs 0 with regard to the situation (d) “it comes to be on bad terms with friends.”

Next, an operation of the step S104 will be specifically described. The ancillary description degree assessment unit 30 determines, for each of the situations output by the situation extraction unit 10, a degree of likelihood that the situation is claimed as an ancillary description in the text.

Specifically, whether a situation is claimed as being ancillary based on a role that the situation plays in the text may be determined with a criterion of whether or not the situation is included in a dependent clause.

For example, the situation (a) “Wife was angry” and situation (b) “I asked the reason” are included in a dependent clause “I asked the reason because Wife was angry” for introduction to a main sentence. Thus, such a situation can be deemed as being written for an ancillary description and determined to have a high ancillary description degree.

Such determination is realized by having a dictionary that describes, as a pattern, which case is deemed as an ancillary description.

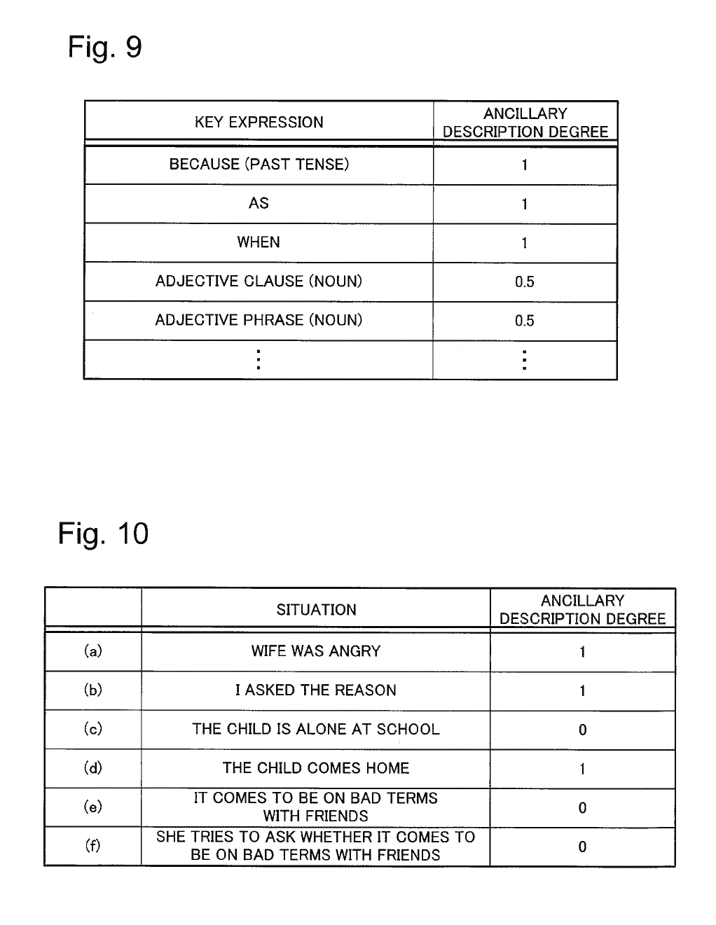

FIG. 9 is a diagram illustrating an example of a rule of ancillary description degrees. A rule relating to dependent clauses that represent time and conditions such as “because (past tense),” “as,” “when” is described. Then, when an expression that matches a key expression illustrated in FIG. 9 appears as an expression included in a situation or an expression that appears around a situation, the ancillary description degree assessment unit 30 deems the ancillary description degree to be 1.

Further, the rule “adjective clause (noun)” and “adjective phrase (noun)” relates to an adnominal clause that is added to modify a noun. When such a rule applies, a different degree may be assigned to each rule, such as deeming the ancillary description degree to be 0.5.

Note that the rule illustrated in FIG. 9 is only an example, and a rule can be arbitrarily determined in accordance with an implementation environment. Further, there is no limit to the number of combinations of key expressions and ancillary description degrees included in a rule and therefore, an arbitrary number thereof can be set.

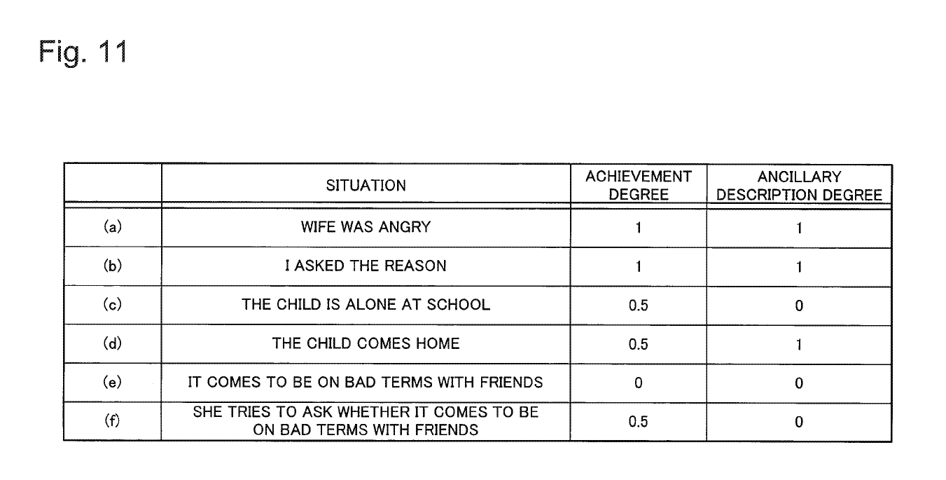

FIG. 11 illustrates an example of data to be output by the ancillary description degree assessment unit 30. This example is a result of output of the ancillary description degree assessment unit 30 when a rule as illustrated in FIG. 9 is applied to the example of the situations output by the situation extraction unit 10 as illustrated in FIG. 5 or 6.

Next, an operation of the step S105 will be specifically described. The interest situation screening unit 40 sorts out a situation that the writer is concerned with among the situations described in the text, based on the achievement degrees output by the achievement degree assessment unit 20 and the ancillary description degrees output by the ancillary description degree assessment unit 30, for the respective situations output by the situation extraction unit 10. The interest situation screening unit 40 sorts out the interest situations, for example, based on the respective situations, as illustrated in FIG. 11, output by the situation extraction unit 10, and the achievement degrees and ancillary description degrees for the respective situations.

In the present exemplary embodiment, a situation with a high achievement degree and a situation with a low ancillary description degree are treated as interest situations. Thus, with a scale of the achievement degree as only one criterion, a situation can be determined whether to be an interest situation or not. Alternatively, with a scale of the ancillary description degree as only one criterion, a situation can be determined whether to be an interest situation or not. Indeed, to determine with higher accuracy, it is preferable that the determination is made by a combination of both the achievement degree and the ancillary description degree.

Therefore, as will be described below, the interest situation screening unit 40 deems a situation with a high achievement degree and a low ancillary description degree as an interest situation, and outputs the situation with a high achievement degree and a low ancillary description degree as the interest situation.

For example, by performing subtraction of the ancillary description degree from the achievement degree, a situation with a value of a result of the subtraction being more than 0 is sorted out as the interest situation, and then, the sorted out situation can be output.

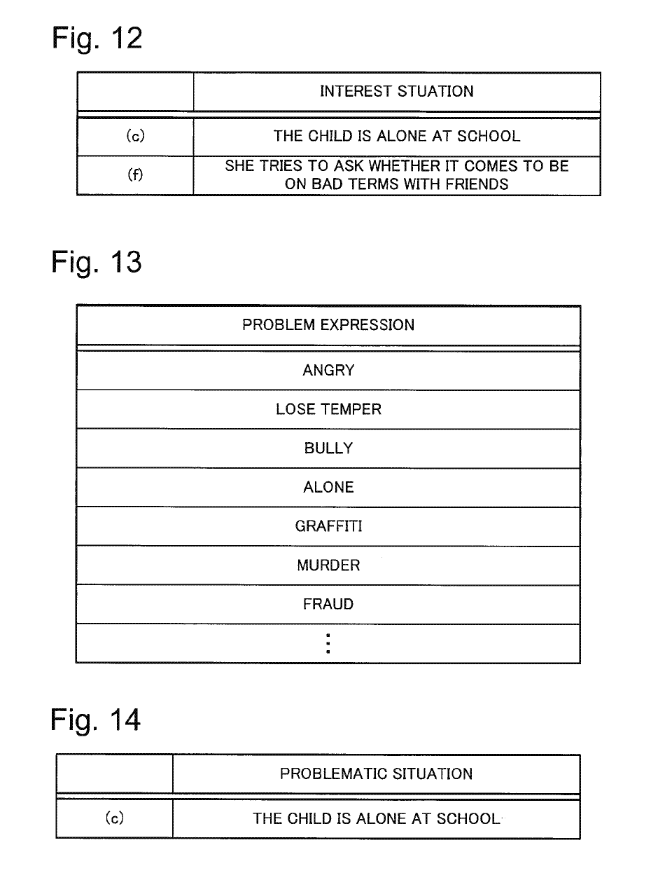

FIG. 12 is a diagram illustrating an example of data output by the interest situation screening unit 40. As a result of sorting out a situation with a value obtained by subtracting the ancillary description degree illustrated in FIG. 9 from the achievement degree illustrated in FIG. 8 being larger than 0, a situation (c) and a situation (f) are output.

Next, an operation of the step S106 will be specifically described. The problematic degree assessment unit 50 examines whether the situation includes a problem by referring to the problem expression dictionary 60 for the respective situations output by the interest situation screening unit 40, and outputs only a situation that includes a problem as a problem situation.

FIG. 13 is a diagram illustrating an example of the problem expression dictionary 60. Words that are expected to be included in the problem situation are listed. Note that the problem expression dictionary 60 illustrated in FIG. 13 is merely an example and contents of the problem expression dictionary 60 largely change in accordance with the purpose of use to which the present exemplary embodiment is adapted. Further, there is no limit to the number of words included in the problem expression dictionary 60.

The problematic degree assessment unit 50 may output a situation that includes at least one problem expression as a problem situation. Alternatively, the problematic degree assessment unit 50 may count the number of problem expressions included in a situation and output only the situation with which the number exceeds a certain threshold value as a problem situation. In other words, when a situation includes a preset N-number (N is an arbitrary integer of one or more) of problem expressions, the situation may be output as a problem situation.

As a result of the above processing, the present exemplary embodiment provides an effect of enabling detection of a problem situation that a writer particularly considers as problematic among situations mentioned in a text, rather than simply and randomly extracting all situations that include a problem expression.

Note that, while the above-described exemplary embodiment is a preferred exemplary embodiment of the present invention, it is not intended to limit the scope of the present invention to the above-described exemplary embodiment. The present invention can be implemented in a variety of modifications within a range not departing from the subject matter of the present invention.

For example, the present exemplary embodiment can not only be applied to analysis of a text created by a third party, such as posting to a bulletin board site on the Internet, or a mental health care system, as described in the Background Art, but also be used in analysis and the like of sentences or books that a specific user wrote in the past.

Further, the present exemplary embodiment can be used for analysis of questionnaire results, analysis of requests and complaints received from customers, or the like.

Further, the present exemplary embodiment can be used, for example, to analyze minutes of internal meetings and the like. In such a case, the present exemplary embodiment may be considered to be applied after recording of contents of a meeting and voice analysis processing thereof.

For any of such purposes, the present exemplary embodiment can sort out a problem situation that a writer (or a speaker) considers as problematic.

Note that the above-described problem situation detection device can be realized by hardware, software, or a combination thereof. In addition, the problem situation detection method performed by the above-described problem situation detection device can also be realized by hardware, software, or a combination thereof. Herein, being realized by software means being realized when a computer reads and executes a program.

The program may be stored using various types of non-transitory computer readable media, which may be supplied to a computer. The non-transitory computer readable media include various types of tangible storage media. Examples of non-transitory computer readable media include a magnetic recording medium (for example, a flexible disk, a magnetic tape, and a hard disk drive), a magneto-optical recording medium (for example, a Magneto-Optical disk), a CD-ROM (Read Only Memory), a CD-R, a CD-R/W, and a semiconductor memory (for example, a mask ROM, a PROM (Programmable ROM), an EPROM (Erasable PROM), a flash ROM, and a RAM (random access memory)). Further, the program may be supplied to a computer through various types of transitory computer readable media. Examples of transitory computer readable media include electric signals, optical signals, and electromagnetic waves. The transitory computer readable media can supply a program to a computer via a wired channel, such as electric cables and optical fibers, or a wireless channel.

The present application is based on Japanese Patent Application No. 2012-169606 (filed as of Jul. 31, 2012) and claims the benefit of priority based on Japanese Patent Application No. 2012-169606 under Paris Convention. The disclosed content of Japanese Patent Application No. 2012-169606 is incorporated herein by reference.

It should be understood that, while the exemplary embodiment of the present invention has been described herein in detail, various changes, substitutions, and alternatives may be made without departing from the spirit and scope of the invention specified in the claims. Further, the inventor intends that, even if the claims are amended in the application procedure, the scope of the equity of the claimed invention will be maintained.

A part or whole of the exemplary embodiment described above may also be described as the following Supplementary Notes but not limited thereto.

(Supplementary Note 1)

A problem situation detection device including:

a situation extraction unit which extracts, from a text as a detection target, descriptions that represent events mentioned in the text in units of situations separately for the events;

an interest situation screening unit which performs sorting out, among the situations which are extracted, both or one of a situation that a writer who writes the situation assumes to be realized and a situation that is not an ancillary description as a situation that the writer is concerned with; and

a problematic degree assessment unit which outputs, as a problem situation, a situation that includes at least one expression which is likely to be a problem among the situations which are sorted out.

(Supplementary Note 2)

The problem situation detection device according to Supplementary Note 1, wherein

the problem situation detection device sorts out a situation that the writer assumes to be realized and that is not the ancillary description.

(Supplementary Note 3)

The problem situation detection device according to Supplementary Note 1 or 2, further including:

an achievement degree assessment unit which detects an achievement degree being a degree of likelihood that the writer assumes the situation to be realized based on an expression included in the situation or an expression appearing around the situation; and

an ancillary description degree assessment unit which determines an ancillary description degree being a degree of likelihood that the situation is not an ancillary description based on an expression included in the situation or an expression appearing around the situation, wherein

the interest situation screening unit performs the sorting out based on the achievement degree and the ancillary description degree.

(Supplementary Note 4)

The problem situation detection device according to Supplementary Note 3, wherein

the achievement degree assessment unit correlates a key expression which may appear around a situation with the achievement degree, and determines the achievement degree by collating the correlated information with a key expression appearing around the situation.

(Supplementary Note 5)

The problem situation detection device according to Supplementary Note 3 or 4, wherein

the ancillary description degree assessment unit determines the ancillary description degree based on whether or not the situation is included in a dependent clause in the text.

(Supplementary Note 6)

The problem situation detection device according to any one of Supplementary Notes 3 to 5, wherein

the problem situation detection device performs subtraction of the ancillary description degree from the achievement degree, and performs sorting out a situation with a value after the subtraction being a predetermined value or more.

(Supplementary Note 7)

The problem situation detection device according to any one of Supplementary Notes 1 to 6, wherein

the problem situation detection device outputs a situation including expressions that are likely to be problems as the problem situation among the situations which are sorted out, a number the expressions being more than a predetermined threshold value.

(Supplementary Note 8)

A problem situation detection method including: extracting, from a text as a detection target, descriptions that represent events mentioned in the text in units of situations separately for the events;

performing sorting out, among the situations which are extracted, both or one of a situation that a writer who writes the situation assumes to be realized and a situation that is not an ancillary description as a situation that the writer is concerned with; and

outputting, as a problem situation, a situation that includes at least one expression which is likely to be a problem among the situations which are sorted out.

(Supplementary Note 9)

A program for problem situation detection causing a computer to function as a problem situation detection device, including:

a situation extraction unit which extracts, from a text as a detection target, descriptions that represent events mentioned in the text in units of situations separately for the events;

an interest situation screening unit which performs sorting out, among the situations which are extracted, both or one of a situation that a writer who writes the situation assumes to be realized or a situation that is not an ancillary description as a situation that the writer is concerned with; and

a problematic degree assessment unit which outputs, as a problem situation, a situation that includes at least one expression which is likely to be a problem among the situations which are sorted out.

### INDUSTRIAL APPLICABILITY

The present invention can be applied to arbitrary purpose as long as the purpose involves detection of a problem situation that a writer considers as problematic.

### REFERENCE SIGNS LIST

1 Computational processing device
2 Communication interface
3 Memory
4 Hard disk drive
5 Input device
6 Output device
7 Bus
10 Situation extraction unit
20 Achievement degree assessment unit
30 Ancillary description degree assessment unit
40 Interest situation screening unit
50 Problematic degree assessment unit
60 Problem expression dictionary
100 Problem situation detection device

What is claimed is:

1. A problem situation detection device comprising:
a situation extraction unit which extracts, from a text as a detection target, descriptions that represent events mentioned in the text in units of situations separately for the events;
an interest situation screening unit which performs sorting out, among the situations which are extracted, both or one of a situation that a writer who writes the situation assumes to be realized and a situation that is not an ancillary description as a situation that the writer is concerned with; and
a problematic degree assessment unit which outputs, as a problem situation, a situation that includes at least one expression which is likely to be a problem among the situations which are sorted out.

2. The problem situation detection device according to claim 1, wherein
the problem situation detection device sorts out a situation that the writer assumes to be realized and that is not the ancillary description.

3. The problem situation detection device according to claim 1, further comprising:
an achievement degree assessment unit which detects an achievement degree being a degree of likelihood that the writer assumes the situation to be realized based on an expression included in the situation or an expression appearing around the situation; and
an ancillary description degree assessment unit which determines an ancillary description degree being a degree of likelihood that the situation is not an ancillary description based on an expression included in the situation or an expression appearing around the situation, wherein
the interest situation screening unit performs the sorting out based on the achievement degree and the ancillary description degree.

4. The problem situation detection device according to claim 3, wherein
the achievement degree assessment unit correlates a key expression which may appear around a situation with the achievement degree, and determines the achievement degree by collating the correlated information with a key expression appearing around the situation.

5. The problem situation detection device according to claim 3, wherein
the ancillary description degree assessment unit determines the ancillary description degree based on whether or not the situation is included in a dependent clause in the text.

6. The problem situation detection device according to claim 3,wherein
the problem situation detection device performs subtraction of the ancillary description degree from the achievement degree, and performs sorting out a situation with a value after the subtraction being a predetermined value or more.

7. The problem situation detection device according to claim 1, wherein
the problem situation detection device outputs a situation including expressions that are likely to be problems as the problem situation among the situations which are sorted out, a number the expressions being more than a predetermined threshold value.

8. A problem situation detection method comprising:
extracting, from a text as a detection target, descriptions that represent events mentioned in the text in units of situations separately for the events;
performing sorting out, among the situations which are extracted, both or one of a situation that a writer who writes the situation assumes to be realized and a situation that is not an ancillary description as a situation that the writer is concerned with; and
outputting, as a problem situation, a situation that includes at least one expression which is likely to be a problem among the situations which are sorted out.

9. A non-transitory computer-readable medium storing a program for problem situation detection causing a computer to function as a problem situation detection device, comprising:
a situation extraction unit which extracts, from a text as a detection target, descriptions that represent events mentioned in the text in units of situations separately for the events;
an interest situation screening unit which performs sorting out, among the situations which are extracted, both or one of a situation that a writer who writes the situation assumes to be realized or a situation that is not an ancillary description as a situation that the writer is concerned with; and
a problematic degree assessment unit which outputs, as a problem situation, a situation that includes at least one expression which is likely to be a problem among the situations which are sorted out.
